(19) United States
(12) Patent Application Publication
(10) Pub. No.: US 2009/0249183 A1
(43) Pub. Date: Oct. 1, 2009

(54) SYSTEM AND METHOD FOR PROCESSING A TEXT FILE

(75) Inventors: Julian David Oates, West Haddon (GB); Ian Matthew Haynes, Pitsford (GB)

Correspondence Address: RISSMAN HENDRICKS & OLIVERIO, LLP, 100 Cambridge Street, Suite 2101, BOSTON, MA, 02114, US

(73) Assignee: Triad Group PLC, Milton Keynes (GB)

(21) Appl. No.: 12/104,085

(22) Filed: Apr. 16, 2008

(30) Foreign Application Priority Data
Mar. 31, 2008 (GB) 0805781.2

(51) Int. Cl. G06F 17/00; G06F 3/048

(52) U.S. Cl. 715/224; 715/764

(57) ABSTRACT

A system and method for processing a text file includes receiving a text file, extracting one or more components from the text file, populating a predefined form with the extracted components, displaying the populated form, and receiving a user input approving the displayed form. The receiving of the text file may include receiving a predefined user input, copying the text file to a predefined location and displaying a graphical user interface, the graphical user interface including the predefined location.

This invention relates to method of, and system for, processing a text file.

It is known to provide an interface for filing in information. For example, if a user is purchasing an item from a website, then it is conventional for the user to be asked to provide shipping details, and also financial details, in order to process the transaction. The user will be presented with one or more consecutive screens of a displayed interface that commonly have multiple fields that the user is expected to complete. These fields will include such details as the name of the user, their address (which is normally broken up into separate fields such as road name, city etc.) and other information such as the method of payment and so on. Other applications use similar interface techniques. For example, if a user is registering to use a website or service provided by a website, then again the user will be expected to fill in the interface fields as requested by the website. This process of providing information is both laborious, and error-prone.

It is therefore an object of the invention to improve upon the known art.

According to a first aspect of the present invention, there is provided a method of processing a text file comprising receiving a text file, extracting one or more components from the text file, populating a predefined form with the extracted components, displaying the populated form, and receiving a user input approving the displayed form.

According to a second aspect of the present invention, there is provided a system for processing a text file comprising a processor arranged to receive a text file, to extract one or more components from the text file, and to populate a predefined form with the extracted components, a display device arranged to display the populated form, and a user input device arranged to receive a user input approving the displayed form.

According to a third aspect of the present invention, there is provided a computer program product on a computer readable medium for processing a text file, the product comprising instructions for receiving a text file, extracting one or more components from the text file, populating a predefined form with the extracted components, displaying the populated form, and receiving a user input approving the displayed form.

Owing to the invention, it is possible to provide a simple and efficient method of providing information. The user can simple provide a text file, which contains all of their necessary details (either in a general and/or specific context) which will then be processed to extract the user's details. These components are then used to populate a predefined form that the user will then approve. The method can further comprise, following displaying of the populated form, receiving a user input modifying the populated form. This allows the user to amend any of the displayed components, in order to update or correct any of the extracted components.

Preferably, the step of receiving the text file comprises receiving a predefined user input copying the text file to a predefined location. The user's task can be made easier by supporting either or both of a drag-and-drop mechanism, or a copy-and-paste mechanism, as a way of allowing the user to copy the text file into the interface. Advantageously, the method further comprises displaying a graphical user interface, the graphical user interface including the predefined location. The graphical user interface can provide a defined box, for example, which the user can utilise to “drop” or “paste” their text file.

The invention is particularly effective in the field of online recruitment. In a traditional recruitment site, users are required to add significant amounts of data about themselves before looking for a job or adding a vacancy. The “Drop and Go” functionality provided by the invention is designed to replace this laborious filling of forms with one simple action. Instead the user simply “pastes” their vacancy or CV as a large block of text into a text box. The system then uses Semantic technology to extract the necessary information and pre-populate the forms. The user is then able to review and correct the data as required.

Embodiments of the present invention will now be described, by way of example only, with reference to the accompanying drawings, in which:—

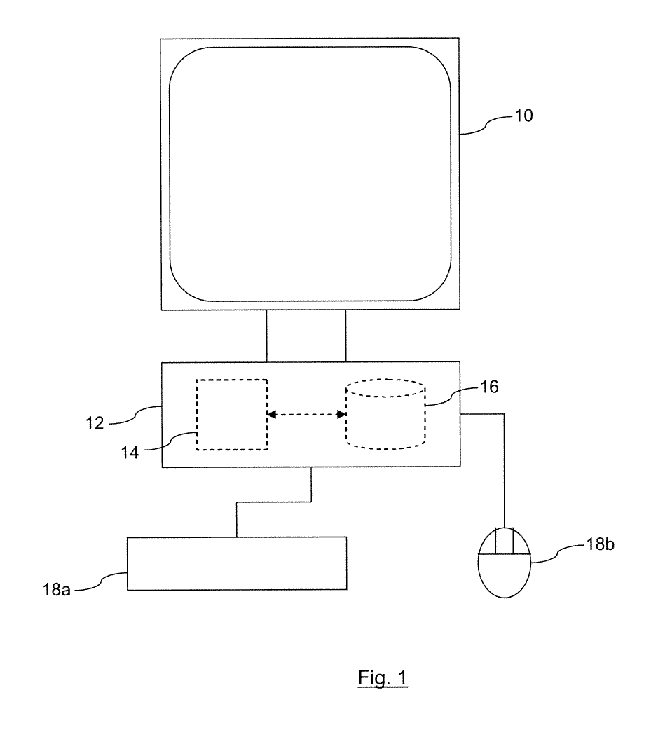

FIG. 1 is a schematic diagram of a system for processing a text file,

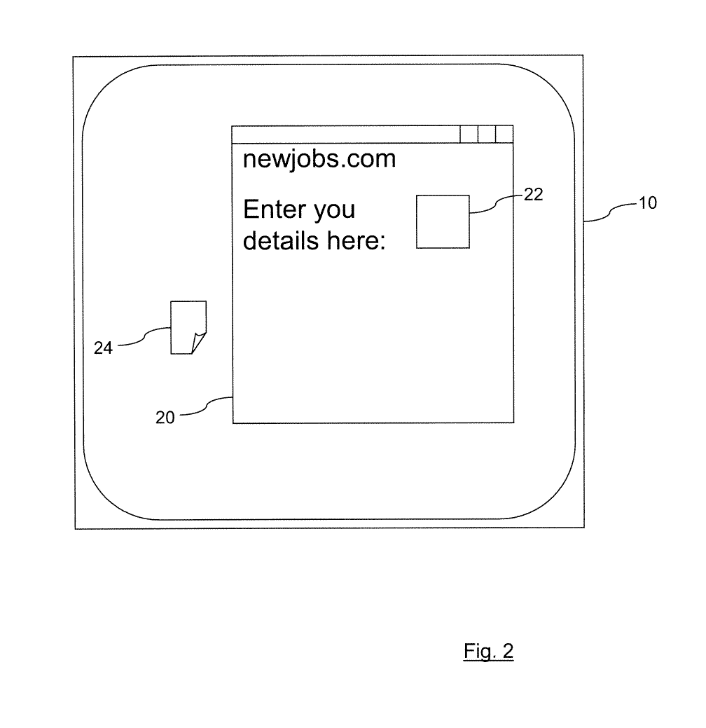

FIG. 2 is a schematic diagram of a graphical display on a display device,

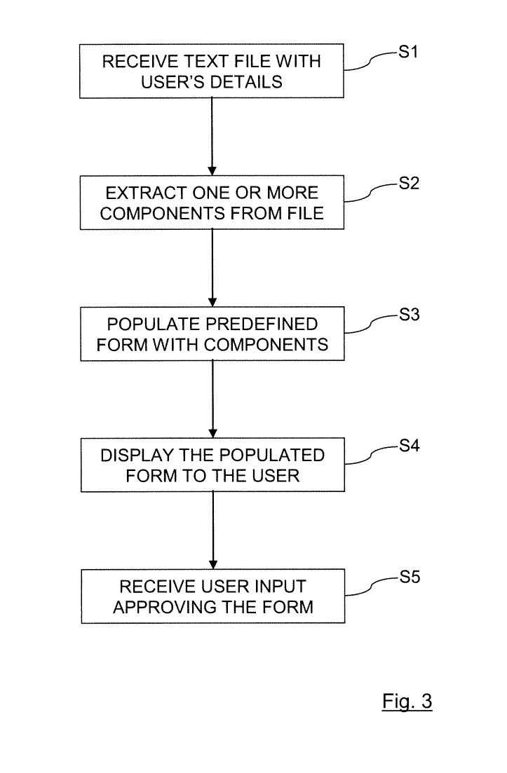

FIG. 3 is a flowchart of the method of processing the text file, and

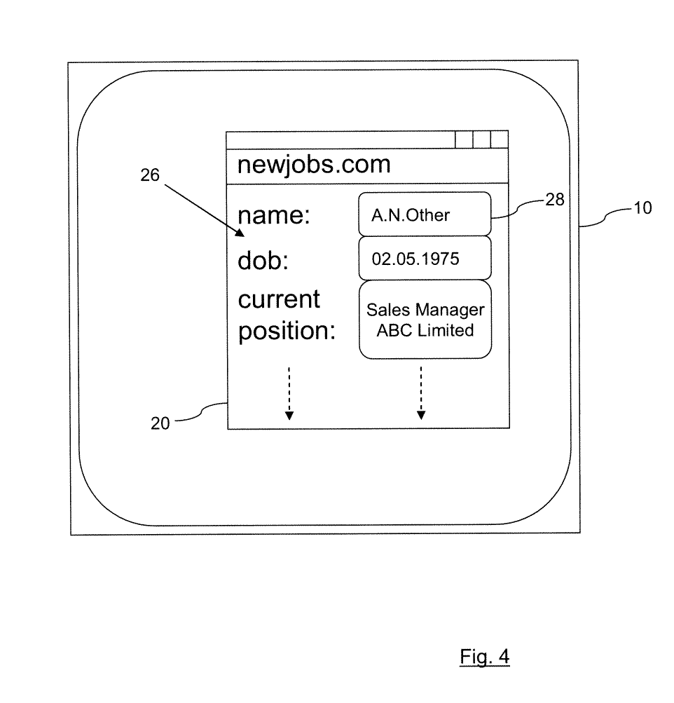

FIG. 4 is a further schematic diagram of the graphical display.

FIG. 1 illustrates a system which can be used to access services provided by a website, for example. The system of this Figure is a conventional personal computer (PC) used in a desktop environment, but could equally be a networked workstation for example. The system comprises a display device 10, which can be any suitable display for viewing documents, such as a CRT display or flat panel display capable of displaying text. The system also comprises a processing component 12, which in turn comprises a large number of processing, storage and input/output elements. Two such elements are illustrated, being a processor 14 and a database 16. The processor 14 is arranged to carry out process tasks and to control the image shown by the display device 10. The database 16 is a local storage device that stores information for use by the processor 14. In the Figure, the database 16 is shown connected to the processor 14 by a local bus. The system also includes conventional user interface devices 18, being a keyboard 18a and a mouse 18b.

A user may wish to access a website for the purpose of making a purchase of goods supplied through the website, or may wish to register with a website in order to seek an employment opportunity. The user will run an application such as a conventional browser to access the website and then, at the appropriate prompt provide their personal details. The user interface to the website is designed to speed up this process and provide an efficient and easy to use method by which the user can provide their details to the website, without having to go through the laborious process of entering their details through a series of fields displayed by the website.

FIG. 2 shows how the interface 20 to the website might look. In addition to the normal features present in a website, the interface 20 also provides a location 22, which the user can employ to submit their details to the website. The location 22 can be implemented as a text field within a form, or as a JAVA function or the like. The user has a text file 24, shown as an icon 24 on the user's desktop which is their curriculum vitae. The user can drag-and-drop this file 24 into the location 22 to supply their details to the website. Alternatively (or additionally) the user can cut-and-paste the contents of the text file 24 into the location 22 to provide the details.

The “Drop and Go” provides an express and easy one click registration. The one click registration process is offered to users as an alternative to the standard registration process, where the user enters their name, address, contact details and selects a user name and password. Instead, the user is able to enter their CV before any other details. The semantic technology then pre-populates their registration details and constructs a user name and password. If the user is happy with the contents of the form, they can complete the process with a single mouse click.

In a similar manner, a one click advertising process can be offered to users as an alternative to the standard advertising process, where the user enters details such as job title, reference number, salary/rate, location and job description. Instead, the user is able to enter their advertisement before any other details. The semantic technology then pre-populates their advertising details. If the user is happy with the contents of the form, they can complete the process with a single mouse click.

The method of processing the text file 24 is summarised in FIG. 3. This processing method can be carried out entirely at the client end of the connections (i.e. by the user's computer) or can be a distributed process, with some of the steps occurring at the client device, and some of the steps occurring at the server end that is maintaining the website. The process comprises, firstly, at step S1, receiving the text file 24. The step of receiving the text file 24, in one embodiment comprises receiving a predefined user input copying the text file 24 to the predefined location 22. To achieve this affect, the process includes displaying the graphical user interface 20, the graphical user interface 20 including the predefined location 22.

After receipt of the file 24, then at step S2 there is performed the extracting of one or more components from the text file 24, and at step S3, the populating of a predefined form with the extracted components. The step of extracting one or more components from the text file 24 can comprise performing a semantic extraction on the text file 24. Once this extraction is performed, then at step S4 there is the displaying of the populated form, and finally at step S5, the process terminates with receiving a user input approving the displayed form. Prior to the user indicating that they accept and approve the populated form, the method can be configured to further comprise, following displaying of the populated form, receiving a user input modifying the populated form. This allows the user to amend their details, if this is needed.

An example of a populated form 26 is shown in FIG. 4, which has been generated after the user has drag-and-dropped their CV (the file 24) into the location 22 shown in the graphical user interface 20. The processing on the server side of the connection has extracted from the file 24 various components 28 which are used to construct the form 26. In the Figure, it can be seen that the user's name, date of birth (DOB) and current position have been extracted from the file 24. These components 28 are displayed to the user for the user to check and amend or update as desired. Once the user has decided that the populated form 26 is acceptable to them, then they can click on an “OK” button (not shown) to indicate that they approve of the displayed form 26. This provides a much simpler and easier to operate user interface by which a user can provide their details, than the conventional method of filling in numerous fields by hand.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results.

What is claimed is:

1. A method of processing a text file comprising
receiving a text file,
extracting one or more components from the text file,
populating a predefined form with the extracted components,
displaying the populated form, and
receiving a user input approving the displayed form.

2. The method according to claim 1, wherein the step of receiving the text file comprises receiving a predefined user input copying the text file to a predefined location.

3. The method according to claim 2, and further comprising displaying a graphical user interface, the graphical user interface including the predefined location.

4. The method according to claim 1 and further comprising, following displaying of the populated form, receiving a user input modifying the populated form.

5. The method according to claim 1, wherein the step of extracting one or more components from the text file comprises performing a semantic extraction on the text file.

6. A system for processing a text file comprising
a processor arranged to receive a text file, to extract one or more components from the text file, and to populate a predefined form with the extracted components,
a display device arranged to display the populated form, and
a user input device arranged to receive a user input approving the displayed form.

7. The system according to claim 6, wherein the user input device is further arranged to receive a predefined user input copying the text file to a predefined location.

8. The system according to claim 7, wherein the display device is further arranged to display a graphical user interface, the graphical user interface including the predefined location.

9. The system according to claim 6 wherein the user input device is further arranged, following displaying of the populated form, to receive a user input modifying the populated form.

10. The system according to claim 6 wherein the processor is arranged, when extracting one or more components from the text file, to perform a semantic extraction on the text file.

11. A computer program product for use with a computer system, the computer program product comprising a computer readable medium having embodied therein program code for processing a text file, the program code comprising:
program code for receiving a text file,
program code for extracting one or more components from the text file,
program code for populating a predefined form with the extracted components,
program code for displaying the populated form, and
program code for receiving a user input approving the displayed form.

12. The computer program product according to claim 11, wherein the program code for receiving the text file comprises program code for receiving a predefined user input copying the text file to a predefined location.

13. The computer program product according to claim 12, and further comprising program code for displaying a graphical user interface, the graphical user interface including the predefined location.

14. The computer program product according to claim 11 and further comprising program code for following displaying of the populated form, receiving a user input modifying the populated form.

15. The computer program product according to claim 11, wherein the program code for extracting one or more components from the text file comprise program code for performing a semantic extraction on the text file.

16. The method according to claim 2 and further comprising, following displaying of the populated form, receiving a user input modifying the populated form.

17. The method according to claim 3, and further comprising, following displaying of the populated form, receiving a user input modifying the populated form.

18. The system according to claim 7 wherein the user input device is further arranged, following displaying of the populated form, to receive a user input modifying the populated form.

19. The system according to claim 8, wherein the user input device is further arranged, following displaying of the populated form, to receive a user input modifying the populated form
